(19) United States
(12) Patent Application Publication
(10) Pub. No.: US 2003/0179594 A1
(43) Pub. Date: Sep. 25, 2003

(54) Device for effecting the basic interference suppression of a matrix converter

(76) Inventors: Manfred Bruckmann, Nurnberg (DE); Olaf Simon, Bruchsal (DE)

Correspondence Address: HENRY M FEIEREISEN, LLC, 350 FIFTH AVENUE, SUITE 4714, NEW YORK, NY, 10118, US

(21) Appl. No.: 10/344,774

(22) PCT Filed: Aug. 3, 2001
(86) PCT No.: PCT/DE01/02978

(30) Foreign Application Priority Data
Aug. 16, 2000 (DE) 10039957.6

(51) Int. Cl. H02M 7/5387

(52) U.S. Cl. 363/132

(57) ABSTRACT

The invention relates to a device for effecting the basic interference suppression of a matrix converter (2) comprising an input filter (10) provided with capacitors (14). According to the invention, a suppression capacitor (CY1,CY2,CY3) is provided for each input phase (U, V, W) of the matrix converter (2). Said suppression capacitors are electrically connected in star, and the star point (16) thereof is connected in an electrically conductive manner to the ground potential. These suppression capacitors (CY1,CY2,CY3), which are electrically connected in star, are electrically connected in parallel to the capacitors (14) of the input filter (10). By using few capacitors and an input filter (10) of a matrix converter (2), a device is thus obtained for effecting the basic interference suppression of the matrix converter (2). This device can also be considered, analogous to a frequency converter, as a network filter.

The invention relates to a device for effecting the basic interference suppression of a matrix converter with an input filter provided with capacitors.

A matrix converter is a self-commutated direct converter. It enables the conversion of a constant three-phase system into a system with variable voltage and frequency. Through the arrangement of the bidirectional power switches in a 3×3 switch matrix, one of the three output phases of the matrix converter can in each case be electrically connected to an input phase. One phase of the matrix converter comprises an arrangement of three bidirectional power switches which, in each case, are connected on the one hand to an input phase and on the other hand to an output phase. An arrangement of this type is also referred to as a 3×1 switch matrix. The matrix converter does not require an intermediate circuit. The self-commutated direct converter offers the advantage that, due to the topology, it has a recovery capability and achieves sinusoidal mains currents through correspondingly designed control.

The bidirectional power switches of the matrix converter in each case have two antiserially connected semiconductor switches. Insulated Gate Bipolar Transistors (IGBT) are preferably used as semiconductor switches, which in each case have an antiparallel diode. Bidirectional power switches designed in this way are preferably used in converters for small and medium powers. Through the control of these semiconductor switches of the bidirectional power switches, a current path is in each case through-connected in a direction determined by the arrangement of the semi-conductor switches. If both semiconductor switches of a bidirectional power switch are controlled, the latter is bidirectionally activated and a current flow is enabled in both directions. This creates a safe electrical connection between an input phase and an output phase of the matrix converter. If only one semiconductor switch of a bidirectional power switch is controlled, the latter is unidirectionally activated, creating an electrical connection between an input phase and an output phase of the matrix converter for the one preferred current direction only.

With optimal control, sinusoidal mains current consumption is possible. In order to prevent overload of the feeding system with pulse-frequency harmonics, the matrix converter additionally requires an input filter comprising LC components. In order to permit the smallest possible input filter structure, a high switching frequency of the bidirectional power switch of the matrix converter is advantageous. The switching frequency is typically several kHz.

As with all electrical devices, a converter must also remain functional in an electromagnetic environment. It must be able to withstand external electromagnetic influences and itself in turn produce minimal electromagnetic interference. The behavior of devices in terms of these criteria is referred to as electromagnetic compatibility, abbreviated to EMC. Every device is therefore a source and a recipient of interference. A distinction is essentially made between immunity to interference and interference capacity. Immunity to interference is the capacity of a device to withstand external electrical and electromagnetic influences. Interference behavior characterizes the electrical or electromagnetic interference emitted by the device.

Interference emitted by the converter is generally caused by rapid switching processes. There are therefore three potential sources of interference in the current design of a converter:

1. The rapid switching processes in the power component essentially determine the extent of the interference emitted by the converter. In converters with pulse width modulation, the level of the PWM clock frequency additionally determines the extent of the interference.

2. The circuit power supply unit for the internal voltage supply of the converter.

3. The clock generation for the internal microprocessor or microcontroller.

This interference then undergoes conducted propagation in the form of a radio-frequency interference variable overlaid on the input variables of the converter. “Radio interference suppression” over a specific frequency range is determined as a measure of the conducted interference. A radio interference suppression filter is an effective remedy against conducted interference. A combination of a radio interference suppression filter and a line choke in one housing is also referred to as a line filter in frequency converters. A line filter of this type can be disposed immediately adjacent to a frequency converter, so that a connection cable between the frequency converter and the line filter is extremely short. As a result, wiring outlay is minimal compared with an arrangement comprising individual components. By means of a line filter in a frequency converter, also referred to as an indirect voltage converter, the interference current is fed back via capacitors with a high dielectric strength, also referred to as Y-capacitors, of the line filter into the line filter and from there via the diodes of the rectifier of the frequency converter into its intermediate voltage circuit. These interference currents to ground increase with increasing switching frequency.

However, a matrix converter has no intermediate voltage circuit, so that the interference currents cannot be fed back via Y-capacitors into the indirect voltage converter.

Similarly, these interference currents cannot be fed back via Y-capacitors of a line filter and via the diodes into an intermediate voltage circuit.

Since no intermediate voltage circuit exists in a matrix converter, the known measures for the frequency converter cannot be transferred to a matrix converter.

Optimized input filters for a matrix converter are known from the publication entitled “A theoretical and practical consideration of optimised input filter design for a low loss matrix converter”, by P. W. Wheeler, H. Zhang and D. A. Grant, printed in the conference publication entitled “Power Electronics and Variable-Speed Drives”, Oct. 26-28, 1994, or from the publication entitled “Optimised input filter design and low-loss switching techniques for a practical matrix converter”, by P. Wheeler and D. Grant, printed in “IEE Proc. Electr. Power Appl.”, Vol. 144, no. 1, January 1997. A multi-stage LC filter and a single-stage LC filter with a tuned harmonic filter circuit are proposed as optimized input filters. The second design is less attractive due to component tolerance and temperature dependency. The disadvantage of a single-stage LC filter is its structural volume. The single-stage LC filter with the tuned filter circuit is the most economical filter in terms of cost and structural volume, with which the harmonics of the switching frequency are reduced.

The object of the invention is to specify a device for effecting the basic interference suppression of a matrix converter with which asymmetrical interference currents can be specifically discharged.

This object is achieved according to the invention with the features of claim 1.

The circuit for asymmetrical interference currents is closed in that star-connected interference suppression capacitors are connected electrically in parallel with the capacitors of the input filter of the matrix converter, whereby their star point is connected in an electrically conductive manner to the ground potential. These asymmetrical interference currents can thus be specifically discharged, whereby the environment of the matrix converter is affected by as little interference as possible.

In an advantageous design form of the device for effecting the basic interference suppression of a matrix converter, this device has star-connected interference suppression capacitors with a low dielectric strength, whereby the star point is connected in an electrically conductive manner to the ground potential by means of a capacitor with a high dielectric strength. This produces a particularly low-cost design form of the device for effecting the basic interference suppression of a matrix converter.

In both design forms of the device for effecting the basic interference suppression of a matrix converter, the capacitance value of the capacitors of the input filter can be reduced by using interference suppression capacitors. As a result, the structural volume of the input filter of the matrix converter remains approximately unchanged, even though further components are added.

In a further design form of the device for effecting the basic interference suppression of a matrix converter, the capacitors of the input filter of the matrix converter are electrically connected in star, whereby the star point of these capacitors is connected in an electrically conductive manner to the ground potential by means of an interference suppression capacitor. As a result, through the addition of a further component, the known input filter of a matrix converter becomes a device for effecting the basic interference suppression of a matrix converter. The capacitor outlay for the basic interference suppression device of the matrix converter is at its lowest in this design form.

The invention is explained in more detail with reference to the drawing, in which a plurality of design forms of the device according to the invention for effecting basic interference suppression of a matrix converter are schematically illustrated:

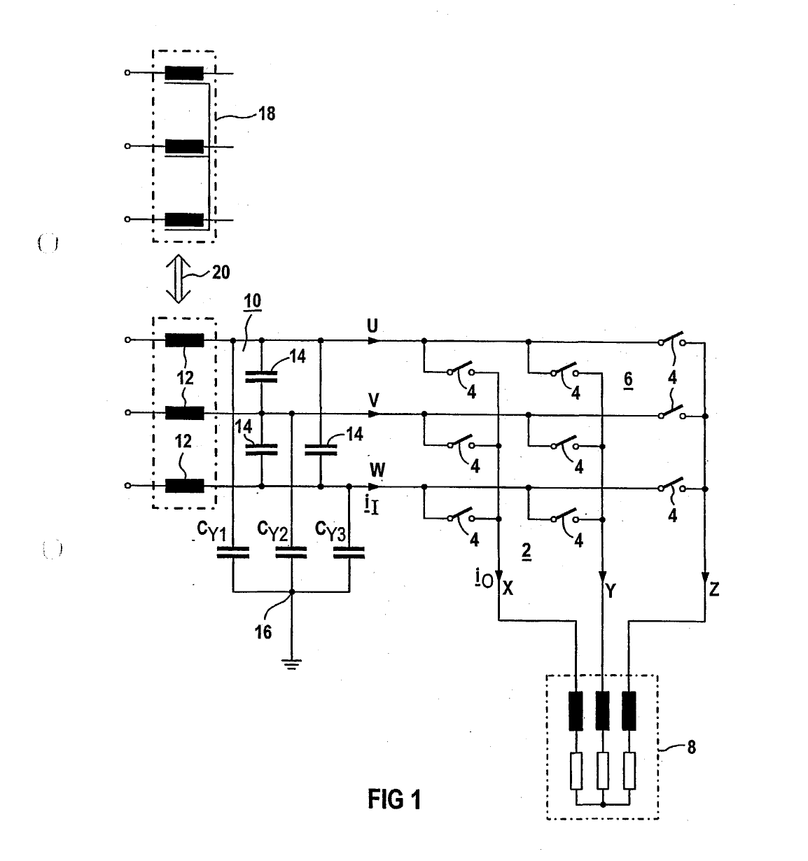

FIG. 1 shows a first design form of the device according to the invention for effecting the basic interference suppression of a matrix converter whereas

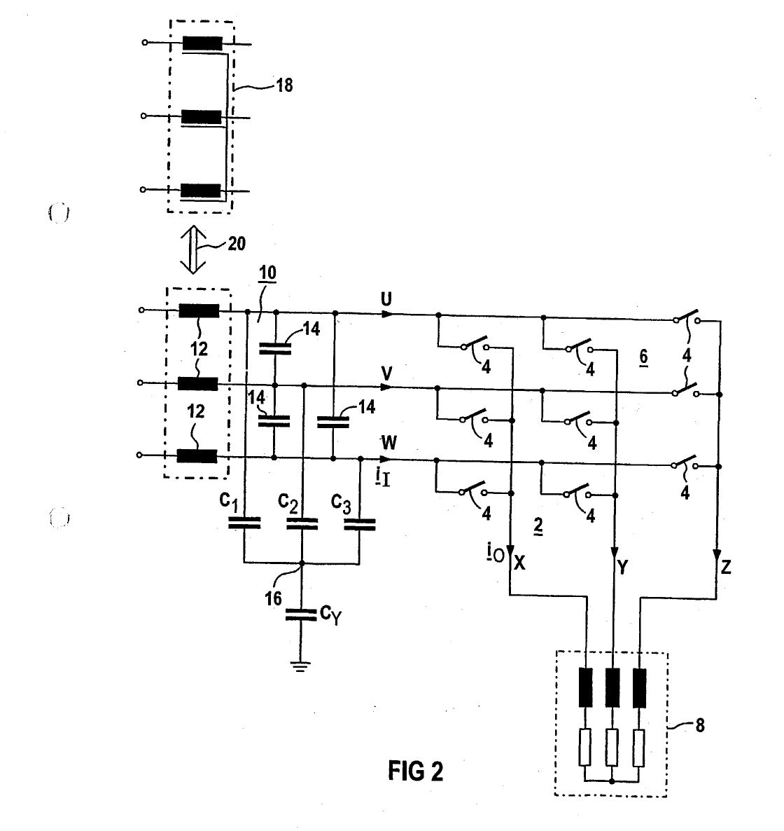

FIG. 2 shows a second design form of the device according to the invention, and

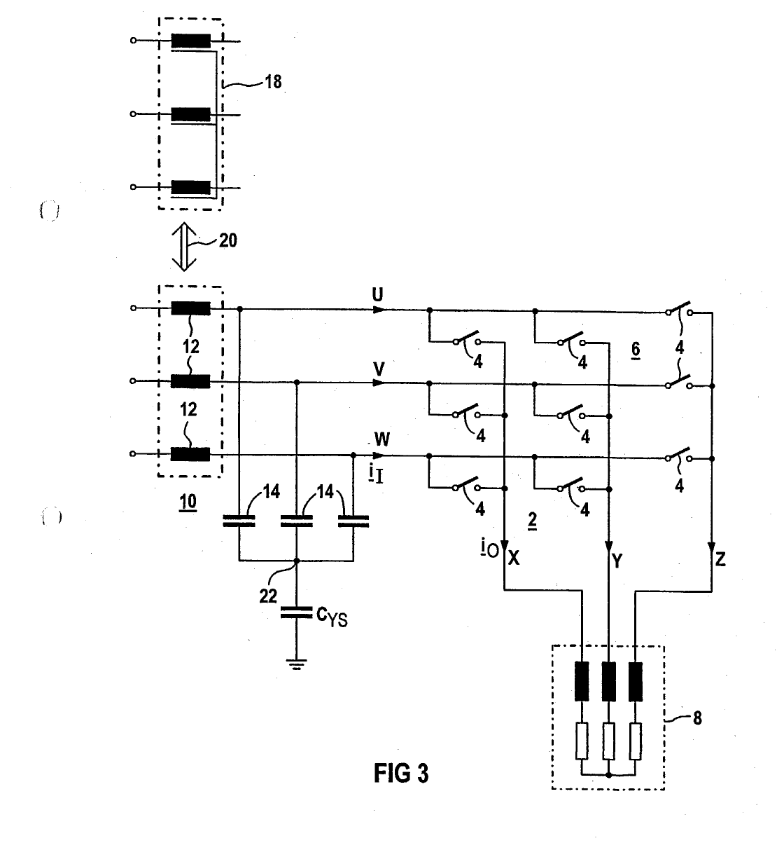

FIG. 3 shows a particularly advantageous design form of the device according to the invention.

FIG. 1 shows a first design form of the device according to the invention for effecting the basic interference suppression of a matrix converter 2. This matrix converter 2 has nine bidirectional power switches 4, which are arranged in a 3×3 switch matrix 6. Due to the arrangement of the nine bidirectional power switches 4 in a 3×3 switch matrix 6, each output phase X, Y, Z can be switched to any required input phase U, V, W. One phase of this matrix converter 2 has three bidirectional power switches 4, which can connect an output phase X or Y or Z to the input phases U, V, W. This matrix converter phase has a 3×1 switch matrix. An inductive load, for example an asynchronous motor, is connected to the output phases X, Y, Z of the matrix switch 2.

The input phases U, V and W are linked to an input filter 10, which is connected on the input side to a mains system (not shown in more detail). This input filter 10 is designed as a single-stage LC filter and has inductors 12 and capacitors 14. These capacitors 14 are shown here in a triangular configuration, although a star circuit (FIG. 3) is also possible. The inductors 12 are disposed in the feeder lines to the capacitors 14, so that their charge currents are smoothed. If the mains system (not shown in more detail) has an inductance which is sufficient for the function of the input filter 10, no inductors are required in the input filter 10. Pulse-frequency harmonics are eliminated from the feeding mains system by means of this input filter 10. The higher the switching frequency of the bidirectional power switches 4 of the matrix converter 2, the smaller the design of the input filter 10 can be.

Star-connected interference suppression capacitors C_{Y1}, C_{Y2}, CY₃, for example with a high dielectric strength, are connected electrically in parallel with the triangular-connected capacitors 12 of the input filter 10. The star point 16 of these star-connected interference suppression capacitors C_{Y1}, C_{Y2}, C_{Y3} is connected in an electrically conductive manner to the ground potential. A ground connection which is as close as possible to the interference source, i.e. the matrix converter 2, should be selected here. A circuit for an asymmetrical interference current is closed by means of these interference suppression capacitors C_{Y1}, C_{Y2}, C_{Y3}.

Due to the addition according to the invention of interference suppression capacitors C_{Y1}, C_{Y2}, C_{Y3}, the input filter 10 of the matrix converter 2 becomes a device for effecting the basic interference suppression of the matrix converter 2, due to the contact protection for persons with a high dielectric strength.

If asymmetrical interference currents are to be even more highly suppressed, the existing inductors 12 of the input filter type 10 of the matrix converter 2 can be replaced by a current-compensating choke 18, or inductors 12 can be added. The replacement option is shown by the arrow 20. The inductors 12 of the input filter 10 can also be replaced by a five-limb core three-phase choke, which, for the sake of clarity, is not shown in more detail in this illustration. These different design forms of the inductors 12 of the input filter 10 do not change the asymmetrical interference currents in any way.

FIG. 2 shows a second design form of the device according to the invention for effecting the basic interference suppression of a matrix converter 2. This second design form differs from the first design form according to FIG. 1 in that interference suppression capacitors C₁, C₂, C₃ with a low dielectric strength are used instead of the interference suppression capacitors C_{Y1}, C_{Y2}, C_{Y3}, for example with a high dielectric strength. These interference suppression capacitors C₁, C₂, C₃ are also electrically connected in star. To provide contact protection of persons, the star point 16 of the star-connected interference suppression capacitors C₁, C₂, C₃ with a low dielectric strength is connected in an electrically conductive manner to the ground potential by means of a capacitor C_{Y} with a high dielectric strength. In this design form, too, the inductors 12 can be designed as a current-compensating choke 18 or as a five-limb core three-phase choke.

The advantage of this second design form is that, instead of three capacitors C_{Y1}, C_{Y2}, C_{Y3}, for example with a high dielectric strength, only one capacitor C_{Y} with a high dielectric strength is required. As a result, the capacitors C₁, C₂, C₃ and C_{Y} require much less space than the capacitors C_{Y1}, C_{Y2}, C_{Y3}, so that the former can be integrated without physical modification of the input filter 10 into the latter. This second design form is significantly more economical.

FIG. 3 shows a third design form of the device for effecting the basic interference suppression of a matrix converter 2. This third design form differs from the aforementioned design forms of FIGS. 1 and 2 in that the capacitors 14 of the input filter 10 are electrically star-connected, and the star point 22 of these star-connected capacitors 14 is connected in an electrically conductive manner to the ground potential by means of an interference suppression capacitor C_{YS}. With this design form, the input filter 10 can be expanded with the aid of a single interference suppression capacitor C_{YS} with a high dielectric strength into a device for effecting the basic suppression of a matrix converter 2. An input filter 10 of a matrix converter and an EMC filter can thus be combined with little capacitor outlay to form a line filter for a matrix converter 2. The inductors 12, if provided, can also be replaced in this design form with a current-compensating choke 18 or a five-limb core three-phase choke. A ground connection as close as possible to the interference source of interference currents, i.e. the matrix converter 2, is similarly selected.

1. A device for effecting the basic interference suppression of a matrix converter (2) with an input filter (10) provided with capacitors (14), whereby an interference suppression capacitor (C_{Y1}, C_{Y2}, C_{Y3}) is provided for each input phase (U, V, W) of the matrix converter (2), said capacitors being electrically star-connected, the star point (16) of which is connected in an electrically conductive manner to the ground potential, and whereby these electrically star-connected interference suppression capacitors (C_{Y1}, C_{Y2}, C_{Y3}) are connected electrically in parallel with the capacitors (14) of the input filter (10).

2. The device as claimed in claim 1, characterized in that interference suppression capacitors (C₁, C₂, C₃) with a low dielectric strength are provided instead of the interference suppression capacitors (C_{Y1}, C_{Y2}, C_{Y3}), and in that the star point (16) is connected to ground potential by means of a capacitor (Cy) with a high dielectric strength.

3. The device as claimed in claim 1 with star-connected capacitors (14) of the input filter (10), characterized in that their star point (22) is connected to ground potential by means of an interference suppression capacitor (C_{YS}).

4. The device as claimed in claim 1 or 2, characterized in that the capacitors (14) of the input filter (10) are electrically connected in a triangular configuration.

5. The device as claimed in one of the aforementioned claims, characterized in that the input filter (10) has inductors (12) in the feeder lines to the capacitors (14).

6. The device as claimed in claim 5, characterized in that a current-compensated choke (18) is provided as the inductors (12) of the input filter (10).

7. The device as claimed in claim 5, characterized in that a five-limb core three-phase choke is provided as the inductors (12) of the input filter (10).
